(19) United States
(12) Patent Application Publication
(10) Pub. No.: US 2021/0209698 A1
(43) Pub. Date: Jul. 8, 2021

(54) Automated Workplace Emotions Research Tool

(71) Applicants: Minette Bellingan, Eton (GB); Zachariah Marcus Peterson, Portland, OR (US); Aleksandar Pavic, Novi Sad (RS)

(72) Inventors: Minette Bellingan, Eton (GB); Zachariah Marcus Peterson, Portland, OR (US); Aleksandar Pavic, Novi Sad (RS)

(73) Assignees: Ms. Minette Bellingan, Eton (GB); Zachariah Marcus Peterson, Portland, OR (US); Mr. Aleksandar Pavic, Novi Sad (RS)

(21) Appl. No.: 16/734,424

(22) Filed: Jan. 6, 2020

(51) Int. Cl. G06Q 50/00; G06F 16/958; G06N 3/00; G06N 20/00; G06N 7/00

(52) U.S. Cl. CPC G06Q 50/01; G06F 16/958; G06N 7/005; G06N 20/00; G06N 3/006

(57) ABSTRACT

A research tool for analyzing moods in the workplace is disclosed. The invention is comprised of an automated, cloud-based software program that acts as a liaison between researchers and subjects—it automatically gathers data and performs statistical analysis within a centralized system. Said software is comprised of a dialog module (chat bot) that interacts with workers on social media platforms such as Facebook, WhatsApp, WeChat and the like. When subjects log their thoughts into said social media platforms on their mobile devices the software commences a dialog (using an artificial intelligence model of the user's preference) with the subjects and places responses into database files on the cloud network. Users can then develop research designs and determine the effect of worker moods on the workplace (production etc.). An object of the invention is to combine social networking data with a chatbot for the purpose of conducting workplace emotions research.

### FIELD OF THE INVENTION

The present invention generally relates to software. More specifically, it relates to human subjects research data gathering and processing software.

### BACKGROUND

The earliest forms of social networking on computers is considered by many to be ‘Arpnet.’ Arpnet was a group of networked computers at MIT in the mid 1970s that exchanged thoughts and ideas that were not necessarily related to research and business communication. Also around this time, the University of Illinois had developed ‘Plato,’ a form of messaging software considered by many to be the first online combination chat room; news report, and blog. In the late 1980s, as personal computing evolved, so too did the proliferation of modems and bulletin board systems (BBS). Compuserve, Prodigy and AOL were three of the largest BBS companies and were the first to migrate to the Internet and message forums (a specific structure of social media) arose with this BBS phenomenon throughout the early 1990s. Today, social media takes many forms—such as texting, short message services (SMS), and ‘facetime’ interactions across a multitude of platforms such as smartphones, tablets, laptops and desktop computers.

As social networking continues to evolve researches have started leveraging automated chatbots to streamline interactions. U.S. patent Ser. No. 10/482,116B1 granted to Manchala disclosed an interactive research report viewing system that utilizes a chatbot with texting social media to guide users through the report viewing process. This disclosure does not interact with subjects in a research study. U.S. patent Ser. No. 10/413,238B1 granted to Cooper and Ussery disclosed a fitness facilitation program that measures subject progress and interacts with them using a chatbot. The system does not allow for customized machine learning models. United States Patent No. US20180365618A1 granted to Hardy, Delbourg-Delphis, Hermsdorff and Lee disclosed a system that measures workplace culture using a chatbot; however, it does not allow for interchangeable machine learning models. Chinese Patent No. CN105393252B granted to Davis et al teaches of a chatbot system that interacts with users and generates medical diagnoses over social media platforms—it also does not allow for multiple machine learning models.

Today, social media continues to expand and researchers have begun looking at ways to mine data from the millions of posts that occur every hour. United States Patent No. US20130124653A1 granted to Lance et. al. disclosed a software system that gathered social media posts and generates a statistical score based on trend analysis. However, it does not incorporate a means to customize statistical analyses. United States Patent No. US20120272160A1 granted to Spivack disclosed a system for analyzing trends in social media posts. United States Patent No. US20110004692A1 granted to Occhino disclosed a software system for examining connections amongst social media users but does not specifically focus on research-based statistical analysis.

### SUMMARY OF THE INVENTION

The device herein disclosed and described provides a solution to the shortcomings in the prior art through the disclosure of a tool for mood research in the workplace. An object of the invention is to provide an automated liaison between subjects and researchers in the form of a chatbot. Human subjects research can be an expensive commitment for a business. Pulling workers off the job and canvasing them with surveys in a large organization takes time and can require a dedicated staff. The current disclosure relies on a chatbot that interacts with participants through phone conversations, text messaging, instant messaging, email and social media. The software artificially replicates researcher and subject interactions and has natural language capabilities (the ability to understand human speech). In addition, subjects can engage with the chatbot after hours or any time of the day or night. Automating the data collection process allows an employer to minimize expenses incurred with employee research.

Another object of the invention is to allow users to customize chatbot interactions with pre-defined scripts based on the underlying machine learning model of their choice. For example, an employer wants to understand their employee's mental health state while at work. The employee can upload an artificial intelligence model, ask specific questions, interprets subject responses and interactions and automatically classifies subjects' mood as fulfilled, content, irritated, depressed, etc.

Another object of the invention is to allow users to perform a wide array of statistical analysis on subject data collected from a population within the system. In the above example, employers may choose to examine whether or not any associations between worker moods and company productivity across multiple factories. The software can automatically perform correlational analysis on data collected from each employee in the cloud network and compare it with productivity figures for each factory.

Another object of the invention is to learn from interactions with subjects as a means for constant data collection improvement. For example, if a participant generates an ambiguous response to a question that does not fit within a predetermined category, the chatbot may ask the subject the same question in a different way in order to elicit a more easily recognized response. This secondary questioning can be stored within the machine learning model on the cloud network and be retrieved again instantly in the future if another subject generates a similar ambiguous response.

Another object of the invention is to provide a central repository for subject postings being generated on existing social media platforms. For example, researchers who are interested in understanding worker attitudes and behavior on the job can solicit participants for a study who are already posting conversations related to work on WeChat and Facebook. Once subjects agree to be part of a survey, their normal posts become diaries and are collected and archived on cloud server networks anonymously and are available to the researchers.

Another object of this invention is to provide a means for users to perform statistical analysis according to their research needs. For example, users can log into the cloud network, select ongoing data posts, and perform quantitative trend analysis on the transcriptions. The backend of the software allows users to program and execute a multitude of statistical analysis and derive results within the system. In addition, statistics can be programmed to perform ‘rolling’ longitudinal analysis as data is retrieved from the social network platforms over time.

Another object of the aforementioned invention is to provide a means for users to select groups of data according to their specific research designs. For example, if a user is seeking data on workers between the ages of 25 and 35 the software will allow them to extract posting data from this demographic.

Another object of the aforementioned invention is to provide a means to deploy discussions and survey instruments to subjects over multiple social media platforms in real time. For example, researchers can structure the software to issue different surveys to random groups of participants on Facebook and Twitter simultaneously, and over select time frames in order to capture various attitudes and behavioral norms. Such results may be useful in controlling variables during multivariate tests.

Another object of the aforementioned invention is to provide a means to gather observational data for other forms of qualitative analysis. For example, when subjects upload video streams to the social networks and are captured by the software, users can review footage and note subject behavior directly and correlate findings with posts if needed. In addition, audio information can be transcribed and recorded into text files on the cloud network.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of the invention being used.

FIG. 2 shows an illustrative view of an embodiment of the invention process.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation.

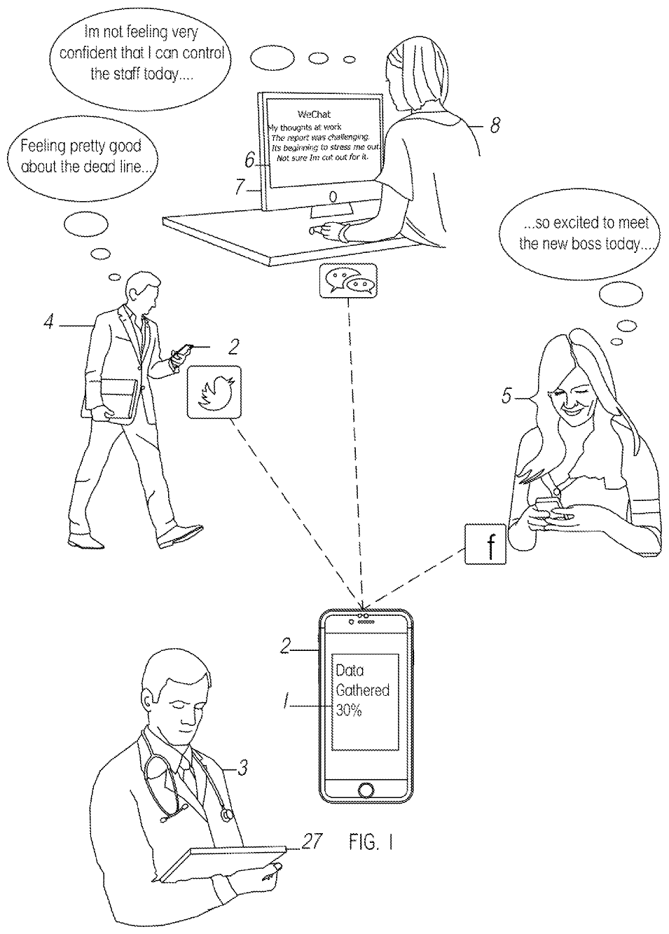

FIG. 1 shows a perspective view of the invention allowing multiple, participating subjects 4, 5 and 8 to record digital diaries using a multitude of social media platforms such as, but not limited to Twitter, Facebook, WeChat and the like on a plurality of computing services including but not limited to: personal desktops 7, laptops, tablets 27, smartphones 2 and the like. The invention software 1 interacting with said diary posts on the aforementioned social media platforms and archiving them on a centralized, cloud based network accessed by research user 3. The invention being comprised of software 1 residing on a cloud network and being transmitted wirelessly from said social platform sites. The aforementioned invention software being written from code that may include, but not be limited to: Java, C++, Visual Basic, Fortran, Basic and the like. The software also compatible with a plurality of operating systems such as, but not limited to: Windows Apple and Android, Linux etc.

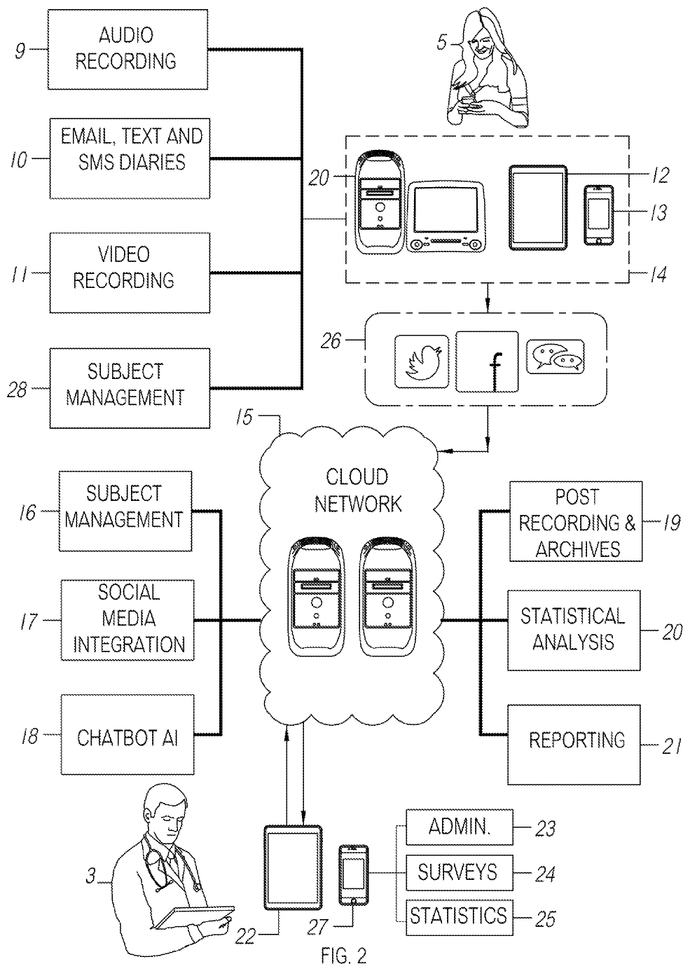

FIG. 2 shows an illustrative view of an embodiment of the invention method. Participating research subjects generating content on devices including but not limited to desktop computers 20, tablets 12 and smartphones 13. Said content posts being comprised of a plurality of data such as, but not limited to text 11, voice, video, audio 9 and the like and uploaded onto the aforementioned social media platforms 26. The invention having software residing on a cloud network 15. Servers on the network being compatible with and interacting with and storing responses on said social media platforms 26 and containing algorithms performing routines such as but not limited to participant subject management 16 (user profiles etc.), social media integration functions 17 (customizing and uploading surveys etc.), interactions between subjects and chatbots 18 (question and answer with recording responses), archiving and organizing captured data 19, statistical analysis customization 20 (qualitative tests, trend analysis and quantitative analysis, and scripting etc.), and output reporting 21 (summary charts, graphs, plots, trends etc.).

The aforementioned servers on the cloud network The chatbots 18 being customizable by a user to automatically implement surveys, and interact via voice with subjects according to underlying models and algorithms of a user's preference and having the ability to learn various responses (often referred to as machine learning) from multiple subjects and adjust questions to subjects based on said learned response history constantly being stored in cloud archives. Embodiments of the invention's software having functions allowing users to perform statistical research on collected conversations and responses such as but not limited to: quantitative multivariate analysis, inferential analysis as well as qualitative trend analysis etc. and have the ability to select and examine groups of data according to predefined designs for inclusion into said analysis. The figure also showing research user 3 interacting with the software's cloud network 15 by means of tablet 22, and smartphone etc. and having permissions to perform functions such as, but not limited to cloud network administration 23 (setting up research designs, multiple survey selections in real time and parameters, uploading chatbot models etc.); subject selection, approvals, survey distributions, coordination and monitoring etc. 24; and statistical analysis 25 (coding, preparing, normalizing, running tests etc.). Still other embodiments of the invention having the capability to automatically generate summary reports of findings from the statistical analysis performed.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention.

What is claimed is:

1. A research tool comprised of the following parts:
(a) software; and
(b) a cloud network.

2. The research tool of claim 1 wherein the software being compatible and interacting with a multitude of existing social networking platforms.

3. The research tool of claim 1 wherein the software providing a central repository for subjects postings on the social networking platforms of claim 2.

4. The research tool of claim 1 wherein the software providing a means to deploy discussions and survey instruments to subjects over multiple social media platforms of claim 2 in real time.

5. The research tool of claim 1 wherein the interacting of claim 2 being comprised of chatbots interacting with users of social media.

6. The research tool of claim 1 wherein the chatbots interacting of claim 5 being customizable to the user's model preference.

7. The research tool of claim 1 wherein the chatbots of claim 5 storing and learning from user's responses by machine learning functions.

8. The research tool of claim 1 wherein the software allowing users to select groups of data collected from chatbots interacting with users of social media of claim 5 according to the user's specific research designs.

9. The research tool of claim 1 wherein the software performing statistical analysis on data collected from chatbots interacting with users of social media of claim 5.

10. The research tool of claim 1 wherein the software generating reports from the results of statistical analysis of claim 9.
